(19) United States
(12) Patent Application Publication
(10) Pub. No.: US 2016/0364410 A1
(43) Pub. Date: Dec. 15, 2016

(54) MAP DRAWING APPARATUS, MAP DRAWING METHOD, AND COMPUTER READABLE MEDIUM

(71) Applicant: MITSUBISHI ELECTRIC CORPORATION, Tokyo (JP)

(72) Inventor: Makoto OTSURU, Tokyo (JP)

(73) Assignee: MITSUBISHI ELECTRIC CORPORATION, Tokyo (JP)

(21) Appl. No.: 15/118,047

(22) PCT Filed: Apr. 9, 2014
(86) PCT No.: PCT/JP2014/060310

§ 371 Date: Aug. 10, 2016

(51) Int. Cl. G06F 17/30; G09B 29/10

(52) U.S. Cl. CPC G06F 17/30241; G06F 17/3087; G09B 29/106

(57) ABSTRACT

In a map drawing apparatus (100), a map database (101) stores data representing a first map element as internal data. A first acquisition unit (103) acquires the internal data from the map database (101). A second acquisition unit (104) receives, via a network such as the Internet, data representing a second map element as external data. A determination unit (105) determines whether or not the first map element represented by the internal data and the second map element represented by the external data received by the second acquisition unit (104) are identical map elements. A drawing unit (106) draws, when the first map element and the second map element are determined to be identical map elements by the determination unit (105), only either one of the first map element and the second map element on a map.

### TECHNICAL FIELD

The present invention relates to a map drawing apparatus, a map drawing method, and a map drawing program.

### BACKGROUND ART

A map display appliance such as a car navigation displays a map using a map database included in the appliance itself. In such a map display appliance, a function to acquire and display external data from an information site on the Internet is demanded.

As a method in which the map display appliance displays the external data, for example, Patent Literature 1 discloses a method for superposing the external data on the map of the map display appliance based on positional information of the external data.

### CITATION LIST

### Patent Literature

Patent Literature 1: JP 2004-70598 A

### SUMMARY OF INVENTION

### Technical Problem

In the method of Patent Literature 1, when the map database included in the map display appliance contains internal data identical to the external data, both the internal and external data are displayed on the map. Therefore, the map becomes unreadable.

The present invention aims to, for example, when internal data identical to external data is stored in a database, make a map readable by drawing only either one of the internal and external data on the map.

### SOLUTION TO PROBLEM

A map drawing apparatus according to one aspect of the present invention includes:

a database to store data representing a first map element as internal data;

a communication unit to receive, via a network, data representing a second map element as external data;

a determination unit to determine whether or not the first map element represented by the internal data stored in the database and the second map element represented by the external data received by the communication unit are identical map elements; and

a drawing unit to draw, when the first map element and the second map element are determined to be identical map elements by the determination unit, either one of the first map element and the second map element on a map.

### ADVANTAGEOUS EFFECTS OF INVENTION

In accordance with the present invention, when the internal data (i.e., first map element) identical to the external data (i.e., second map element) is stored in the database, the map can be made readable by drawing only either one of the internal and external data (i.e., one map element).

### BRIEF DESCRIPTION OF DRAWINGS

FIG. 1 is a block diagram illustrating a configuration of a map drawing apparatus according to a first embodiment.

FIG. 2 is a flowchart illustrating an operation of a determination unit of the map drawing apparatus according to the first embodiment.

FIG. 3 is a diagram for describing a method for reducing a calculation amount in calculating a distance by the determination unit of the map drawing apparatus according to the first embodiment.

FIG. 4 is a diagram for describing a similarity of internal data and external data in the first embodiment.

FIG. 5 is a diagram for describing an effect of the first embodiment.

FIG. 6 is a diagram illustrating an example of a hardware configuration of the map drawing apparatus according to the first embodiment.

### DESCRIPTION OF EMBODIMENTS

An embodiment of the present invention will be described hereinafter with reference to accompanying drawings.

### Embodiment 1

The present embodiment can be applied to various appliances drawing a map such as a car navigation system.

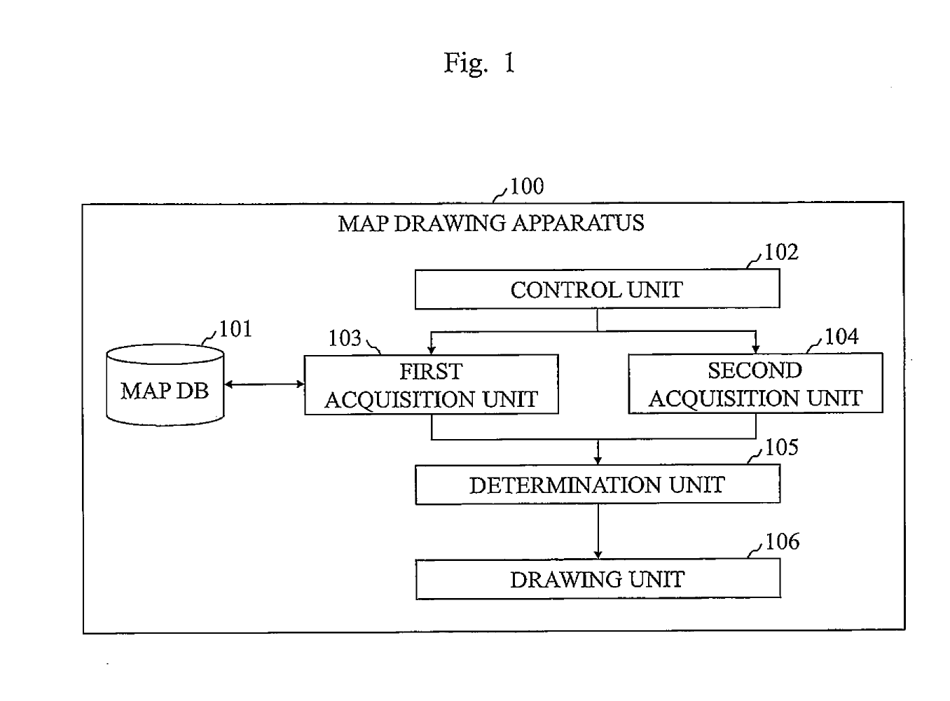

FIG. 1 is a block diagram illustrating a configuration of a map drawing apparatus 100 according to the present embodiment.

Referring to FIG. 1, the map drawing apparatus 100 includes a map database 101 (map DB), a control unit 102, a first acquisition unit 103, a second acquisition unit 104, a determination unit 105, and a drawing unit 106.

The map database 101 is a database to store map data. The map data is various data for drawing the map. The map data includes data representing a map element (hereinafter, referred to as a “first map element”) as internal data. The map element is an element which is displayable on the map such as a facility (for example, retail store or restaurant) or a landmark. The map data stored in the map database 101 is read out by the first acquisition unit 103.

The control unit 102 sets, in response to an input from the outside, parameters necessary to draw the map such as a drawing range, a display scale, and a method for acquiring external data. The control unit 102 transmits the set parameters to the first acquisition unit 103 and the second acquisition unit 104.

The first acquisition unit 103 acquires the necessary map data from the map database 101, the necessary map data being indicated by the parameters transmitted from the control unit 102. The first acquisition unit 103 transmits the acquired map data to the determination unit 105. This map data includes the internal data representing the first map element (for example, facility). Note that, in the description of the present embodiment, the internal data may be used synonymously with the first map element represented by the internal data itself For example, instead of using an expression of drawing or displaying the first map element on the map, there is a case where an expression of drawing or displaying the internal data on the map is used.

The second acquisition unit 104 is an example of a communication unit. The second acquisition unit 104 acquires (i.e., receives), via a network such as the Internet, data representing a map element (hereinafter, referred to as a “second map element”) as the external data from the outside based on the parameters transmitted from the control unit 102. The second acquisition unit 104 may acquire the external data from anywhere. The second acquisition unit 104 transmits the acquired external data to the determination unit 105. Note that, in the description of the present embodiment, the external data may be used synonymously with the second map element represented by the external data itself For example, instead of using an expression of drawing or displaying the second map element on the map, there is a case where an expression of drawing or displaying the external data on the map is used.

The determination unit 105 determines whether or not the internal data included in the map data from the first acquisition unit 103 and the external data from the second acquisition unit 104 are identical. That is, the determination unit 105 determines whether or not the first map element represented by the internal data stored in the map database 101 and the second map element represented by the external data received by the second acquisition unit 104 are identical map elements. The determination unit 105 transmits a determination result to the drawing unit 106.

The drawing unit 106 draws the map, based on the determination result transmitted from the determination unit 105. That is, the drawing unit 106 draws, when the first map element and the second map element are determined to be identical map elements by the determination unit 105, only either one of the first map element and the second map element on the map. It may be determined by an arbitrary reference which one of the first map element and the second map element to be drawn. The drawing unit 106 draws, when the first map element and the second map element are determined not to be identical map elements by the determination unit 105, both of the first map element and the second map element on the map.

Hereinafter, the detail of an operation of the determination unit 105 will be described.

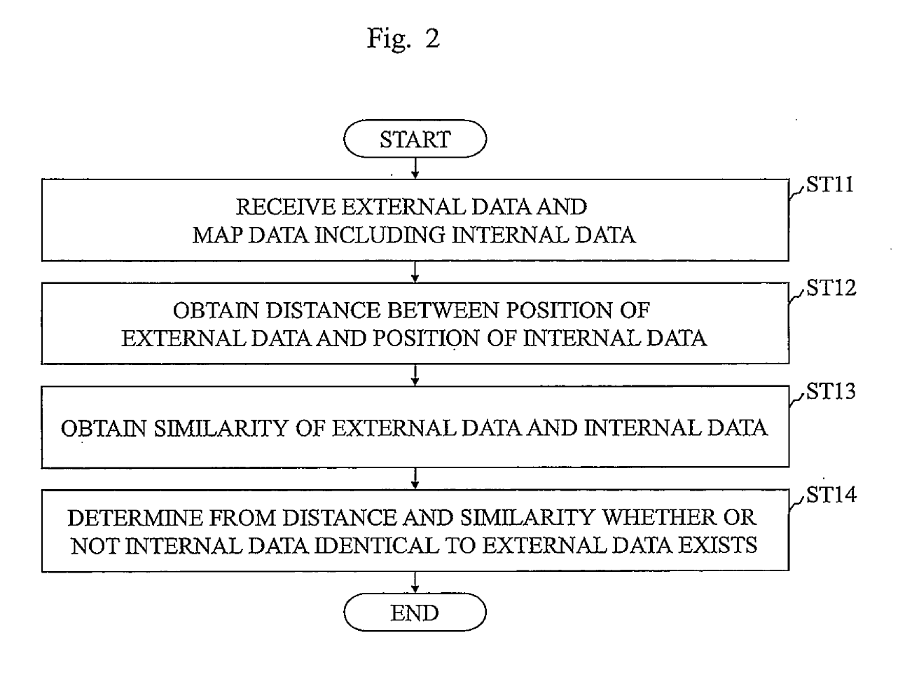

FIG. 2 is a flowchart illustrating the operation of the determination unit 105.

In ST11, the determination unit 105 receives the map data from the first acquisition unit 103 and the external data from the second acquisition unit 104.

The internal data being a part of the map data includes first positional information (for example, latitude and longitude) indicating a position of the first map element. Further, the internal data includes first attribute information indicating an attribute of the first map element. The first attribute information is information indicating, for example, as the attribute of the first map element, a type of the first map element. If the first map element is the facility, a name, a category, or the like of the facility corresponds to the attribute of the first map element. Especially, the category of the facility (for example, retail store or restaurant) corresponds to the type of the first map element.

Similarly, the external data includes second positional information (for example, latitude and longitude) indicating a position of the second map element. Further, the external data includes second attribute information indicating an attribute of the second map element. The second attribute information is information indicating, for example, as the attribute of the second map element, a type of the second map element. Alternatively, the second attribute information is information indicating, as the attribute of the second map element, a transmission source of the external data received by the second acquisition unit 104. If the second map element is the facility, the name or the category of the facility, a supply source of facility information, or the like corresponds to the attribute of the second map element. Especially, the category of the facility (for example, retail store or restaurant) corresponds to the type of the second map element, and the supply source of facility information (for example, restaurant introduction site) corresponds to the transmission source of the external data. The information indicating the transmission source of the external data does not need to be included in the external data from the beginning and may be added to the external data by the second acquisition unit 104.

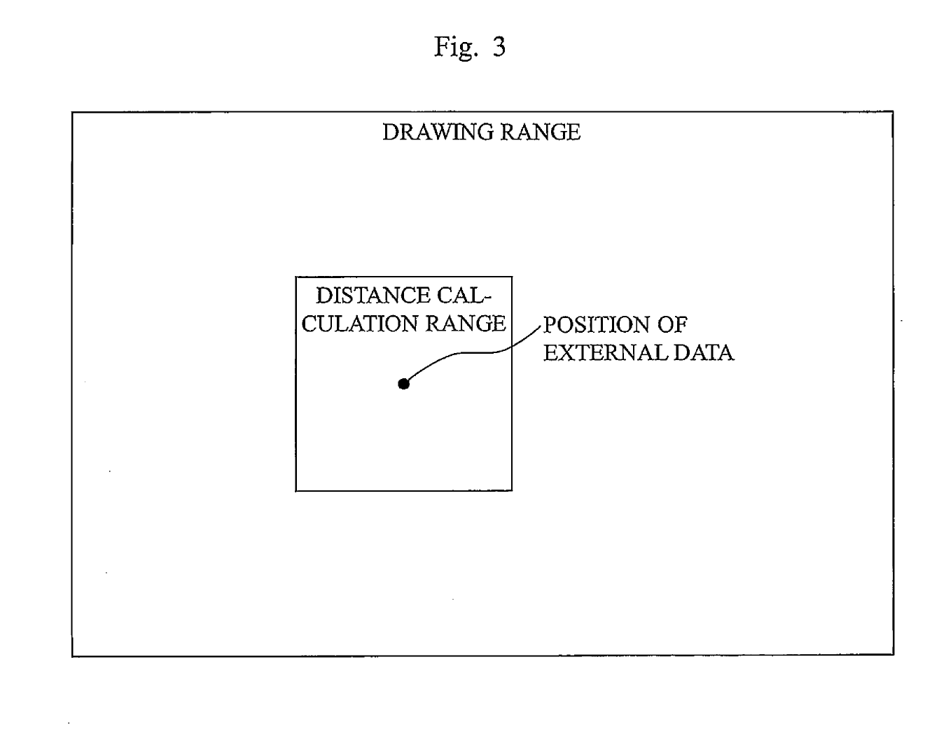

In ST12, the determination unit 105 obtains a distance between the position of the external data received in ST11 and the position of the internal data included in the map data received in ST11. That is, the determination unit 105 obtains the distance between the first map element and the second map element by comparing the first positional information with the second positional information. In this process, if the distance is calculated for all of the internal data within the drawing range, the calculation amount becomes extremely large. Therefore, the determination unit 105 preferably calculates, as illustrated in FIG. 3, the distance only for the internal data (i.e., first map element) included within a certain range (for example, square or circle) centered on the position of the external data (i.e., second map element). It is possible to reduce the calculation amount by limiting the internal data for which the distance is calculated. However, the determination unit 105 may calculate the distance for all of the internal data within the drawing range.

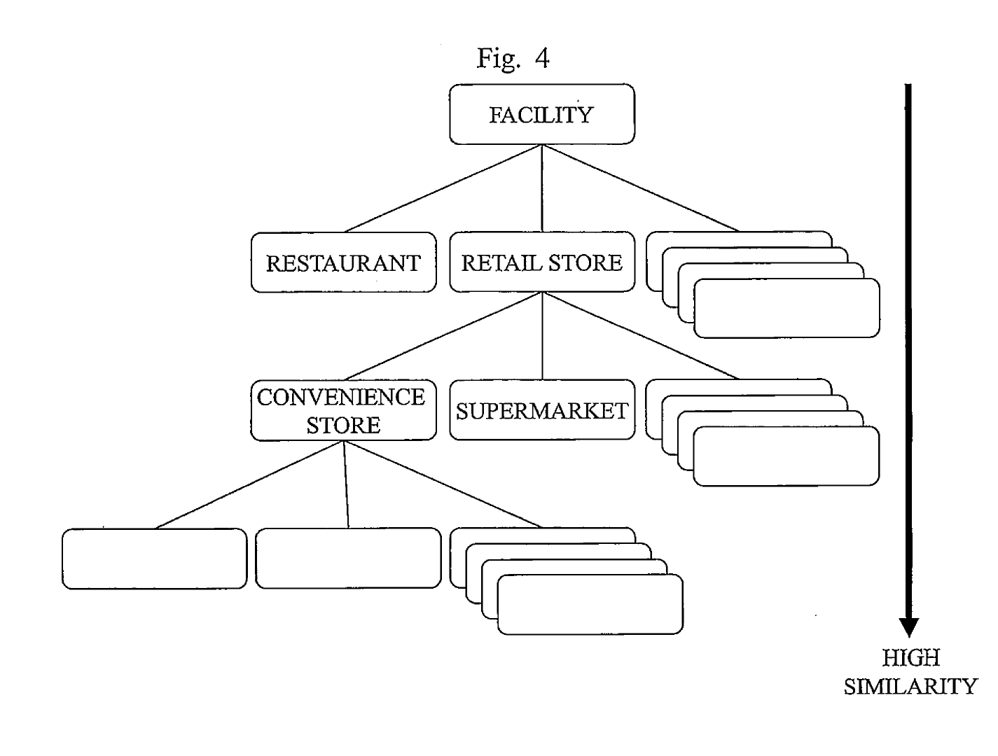

In ST13, the determination unit 105 obtains a similarity of the external data received in ST11 and the internal data included in the map data received in ST11. The similarity is obtained by comparing the name, the category, or the like of the external data with that of the internal data. That is, the determination unit 105 obtains the similarity of the first map element and the second map element by comparing the first attribute information with the second attribute information. It can be made certain that the internal data includes information such as a specific name and a detailed category. However, it is uncertain whether or not the external data includes such information. Therefore, the determination unit 105 preferably determines, as illustrated in FIG. 4, the similarity to be higher as more specific information matches. When the external data does not include information from which the name or the category of the second map element can be identified, the determination unit 105 estimates the category by referring to the information indicating the transmission source of the external data. That is, the determination unit 105 estimates the type of the second map element based on the second attribute information. For example, when the external data is acquired from the restaurant introduction site, the determination unit 105 regards the category of the external data as the “restaurant”.

In ST14, the determination unit 105 determines, from the distance obtained in ST12 and the similarity obtained in ST13, whether or not the map data including the internal data identical to the external data exists. Note that, the determination unit 105 may determine, only from the distance obtained in ST12, whether or not the map data including the internal data identical to the external data exists. That is, the determination unit 105 determines, by at least the distance obtained in ST 12, whether or not the first map element and the second map element are identical map elements.

A specific method for determination is as follows:

Firstly, the determination unit 105 extracts, from among pieces of the internal data for which the similarity is determined to be highest, a piece of the internal data with the closest distance. Then, the determination unit 105 determines the internal and external data to be identical data when the distance between the extracted internal data and the external data is below a threshold value which varies with the similarity. The threshold value is set such that, for example, in a case where the similarity is high and there is a high possibility that the internal and external data are identical, the internal and external data are determined to be identical even when the distance is far, and in a case where the similarity is low and there is a low possibility that the internal and external data are identical, the internal and external data are determined to be identical only when the distance is close. That is, the determination unit 105 sets the threshold value of which size varies with a level of the similarity, and if the distance is smaller than the threshold value, determines the first map element and the second map element to be identical map elements. Thus, the identical map elements can be found more certainly and efficiently.

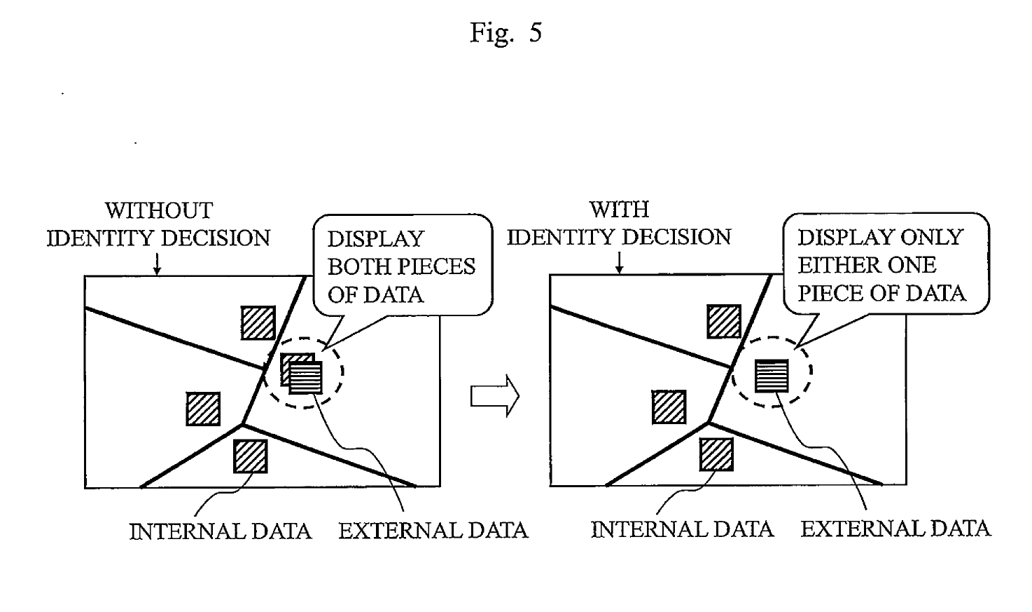

As described above, the map drawing apparatus 100 according to the present embodiment draws, by an identity decision of the internal data and the external data, only either one of the internal and external data (i.e., one map element) on the map when the internal data (i.e., first map element) identical to the external data (i.e., second map element) is stored in the map database 101. Accordingly, as illustrated in FIG. 5, in accordance with the present embodiment, the map becomes readable.

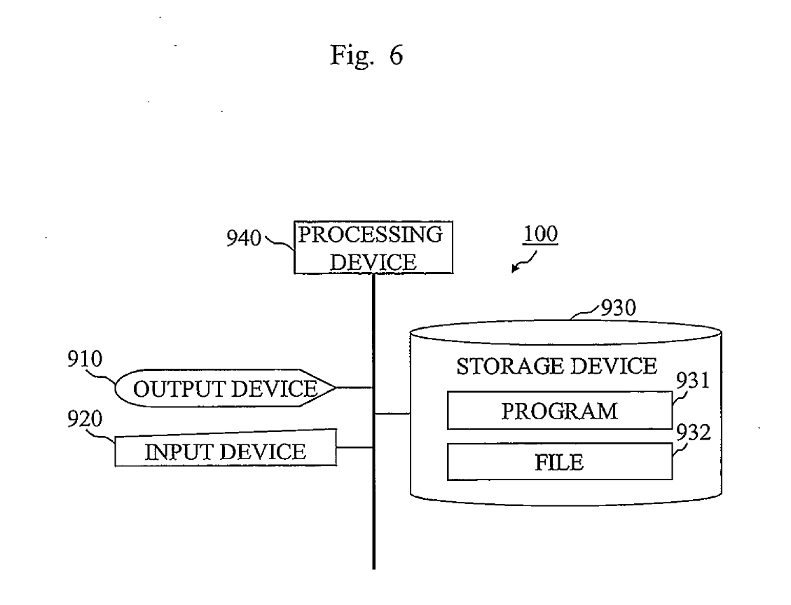

FIG. 6 is a diagram illustrating an example of a hardware configuration of the map drawing apparatus 100.

Referring to FIG. 6, the map drawing apparatus 100 is a computer and includes hardware such as an output device 910, an input device 920, a storage device 930, and a processing device 940. The hardware is used by each unit (each one described as a “unit” in the description of the embodiment of the present invention) of the map drawing apparatus 100.

The output device 910 is, for example, a display device such as an LCD (Liquid Crystal Display), a printer, or a communication module (a communication circuit or the like). The output device 910 is used to output (transmit) data, information, and a signal by each one described as a “unit” in the description of the embodiment of the present invention.

The input device 920 is, for example, a keyboard, a mouse, a touch panel, or a communication module (communication circuit or the like). The input device 920 is used to input (receive) the data, the information, and the signal by each one described as a “unit” in the description of the embodiment of the present invention.

The storage device 930 is, for example, a ROM (Read Only Memory), a RAM

(Random Access Memory), an HDD (Hard Disk Drive), or an SSD (Solid State Drive). The storage device 930 stores a program 931 and a file 932. The program 931 includes a program for executing the process (function) of each one described as a “unit” in the description of the embodiment of the present invention. The file 932 includes the data, the information, the signal (value), and the like for which calculation, processing, reading, writing, use, input, output, and the like are performed by each one described as a “unit” in the description of the embodiment of the present invention.

The processing device 940 is, for example, a CPU (Central Processing Unit). The processing device 940 is connected to other hardware devices via a bus or the like and controls the hardware devices. The processing device 940 reads the program 931 from the storage device 930 and executes the program 931. The processing device 940 is used for the calculation, processing, reading, writing, use, input, output, and the like by each one described as a “unit” in the description of the embodiment of the present invention.

Each one described as a “unit” in the description of the embodiment of the present invention may be the one for which the “unit” is replaced by a “circuit”, a “device”, or an “appliance”. Further, each one described as a “unit” in the description of the embodiment of the present invention may be the one for which the “unit” is replaced by a “step”, a “procedure”, or a “process”. That is, each one described as a “unit” in the description of the embodiment of the present invention is realized solely by software, solely by hardware, or by a combination of the software and the hardware. The software is stored in the storage device 930 as the program 931. The program 931 causes the computer to function as each one described as a “unit” in the description of the embodiment of the present invention. Alternatively, the program 931 causes the computer to execute the process of each one described as a “unit” in the description of the embodiment of the present invention.

The embodiment of the present invention has been described above. The embodiment may be implemented partially. For example, only one of the ones each described as a “unit” in the description of the embodiment may be employed, or any arbitrary combination of some of the ones may be employed. Note that, the present invention is not limited to the embodiment, and various modifications can be made as necessary.

### Reference Signs List

100: map drawing apparatus, 101: map database, 102: control unit, 103: first acquisition unit, 104: second acquisition unit, 105: determination unit, 106: drawing unit, 910: output device, 920: input device, 930: storage device, 931: program, 932: file, and 940: processing device.

1-6. (canceled)

7. A map drawing apparatus comprising:
a database to store data representing a first map element as internal data;
a communication unit to receive, via a network, data representing a second map element as external data;
a determination unit to determine whether or not the first map element represented by the internal data stored in the database and the second map element represented by the external data received by the communication unit are identical map elements; and
a drawing unit to draw, when the first map element and the second map element are determined to be identical map elements by the determination unit, either one of the first map element and the second map element on a map,
wherein the internal data stored in the database includes first positional information indicating a position of the first map element, and first attribute information indicating an attribute of the first map element,
the external data received by the communication unit includes second positional information indicating a position of the second map element, and second attribute information indicating an attribute of the second map element, and
the determination unit obtains a distance between the first map element and the second map element by comparing the first positional information with the second positional information, obtains a similarity of the first map element and the second map element by comparing the first attribute information with the second attribute information, sets a threshold value of which size varies with a level of the similarity, and if the distance is smaller than the threshold value, determines the first map element and the second map element to be identical map elements.

8. The map drawing apparatus according to claim 7,
wherein the first attribute information is information indicating a type of the first map element,
the second attribute information is information indicating a transmission source of the external data received by the communication unit, and
the determination unit estimates a type of the second map element based on the second attribute information.

9. A map drawing method to use a database storing data representing a first map element as internal data, the map drawing method comprising:
receiving by a communication unit, via a network, data representing a second map element as external data;
determining by a determination unit whether or not the first map element represented by the internal data stored in the database and the second map element represented by the external data received by the communication unit are identical map elements; and
when the first map element and the second map element are determined to be identical map elements by the determination unit, drawing by a drawing unit either one of the first map element and the second map element on a map,
wherein the internal data stored in the database includes first positional information indicating a position of the first map element, and first attribute information indicating an attribute of the first map element,
the external data received by the communication unit includes second positional information indicating a position of the second map element, and second attribute information indicating an attribute of the second map element, and
the determination unit obtains a distance between the first map element and the second map element by comparing the first positional information with the second positional information, obtains a similarity of the first map element and the second map element by comparing the first attribute information with the second attribute information, sets a threshold value of which size varies with a level of the similarity, and if the distance is smaller than the threshold value, determines the first map element and the second map element to be identical map elements.

10. A non-transitory computer readable medium storing a map drawing program to cause a computer including a database storing data representing a first map element as internal data to execute:
a communication process to receive, via a network, data representing a second map element as external data;
a determination process to determine whether or not the first map element represented by the internal data stored in the database and the second map element represented by the external data received by the communication process are identical map elements; and
a drawing process to draw, when the first map element and the second map element are determined to be identical map elements by the determination process, either one of the first map element and the second map element on a map,
wherein the internal data stored in the database includes first positional information indicating a position of the first map element, and first attribute information indicating an attribute of the first map element,
the external data received by the communication process includes second positional information indicating a position of the second map element, and second attribute information indicating an attribute of the second map element, and
the determination process obtains a distance between the first map element and the second map element by comparing the first positional information with the second positional information, obtains a similarity of the first map element and the second map element by comparing the first attribute information with the second attribute information, sets a threshold value of which size varies with a level of the similarity, and if the distance is smaller than the threshold value, determines the first map element and the second map element to be identical map elements.
